(19) United States
(12) Patent Application Publication
(10) Pub. No.: US 2006/0212744 A1
(43) Pub. Date: Sep. 21, 2006

(54) Methods, systems, and storage medium for data recovery

(75) Inventors: Alan F. Benner, Poughkeepsie, NY (US); Casimer M. DeCusatis, Poughkeepsie, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/080,717

(22) Filed: Mar. 15, 2005

(51) Int. Cl. G06F 11/00

(52) U.S. Cl. 714/6

(57) ABSTRACT

A geographically distributed array of redundant disk storage devices are interconnected with high bandwidth optical links for disaster recovery for computer data centers. These provide recovery from multiple site failures with less disk storage, less bandwidth, and lower cost than conventional approaches and with potentially faster recovery from site failures or network failures.

### BACKGROUND OF THE INVENTION

1. Field of the Invention

The present invention relates generally to distributed computing, high bandwidth networks for storage, and, in particular, to geographically distributed redundant storage arrays for high availability and disaster recovery.

2. Description of Related Art

There is a large and growing demand for server and storage systems for high availability and disaster recovery applications. Customer interest in this area is driven by many factors, including the high cost of data that is either lost or temporarily unavailable (e.g., millions of dollars per minute), concerns with both natural and man-made disasters (e.g., terrorist attacks, massive power failures, computer viruses, hackers, earthquakes, floods, etc.). Customer interest is also driven by a growing list of compliance regulations for the banking and finance industries that require strict control of data with both legal and financial consequences for non-compliance.

There exist some enterprise disaster recovery and business continuity products and services, such as clusters of servers and storage or remote storage copy and data migration tools for distances—up to 300 km. Some are based on fiber optic wavelength division multiplexing (WDM) products. Some two-site systems include backup processes for backing up data from a primary location to a remote, secondary location.

Many customers have access to multiple locations spread across a metropolitan area. As a result, there is a need for additional recovery points. There is a need for multiple site systems that include three, four or more locations for disaster recovery. Until recently, optical channel extensions in some server and storage systems required the use of dedicated dark fiber. Many WDM and networking companies now plan to offer encapsulation of Fibre Channel storage data into synchronous optical network (SONET) fabrics, making it practical and cost effective to extend the supported distances to 1000 km or more. The customer interest in multiple site systems coupled with the emergence of lower cost, high bandwidth optical links, increases the need for multiple site disaster recovery systems and methods.

### BRIEF SUMMARY OF THE INVENTION

The present invention is directed to methods, systems, and storage mediums for data recovery.

One aspect is a method for data recovery. A stored unit of data is written to a primary storage device at a main location. The stored unit of data is divided into increments. Each increment is 1/n of the stored unit of data, where (n+1) is a number of remote locations and n is at least two. An exclusive-or (XOR) result of an XOR operation on the increments is computed. The increments and the XOR result are sent to a plurality of backup storage devices at the remote locations. The stored unit of data may be recovered even if one of the increments is corrupted or destroyed. Another aspect is a storage unit having instructions stored thereon for performing this method of data recovery.

Another aspect is a system for data recovery, including a main location and N+1 remote locations connected by a network. The main location has N primary storage devices, where N is at least four. The N+1 remote locations each have a backup storage devices for storing 1/N page increments of each page of data from the N+1 primary storage devices and an exclusive-or (XOR) result of an XOR operation on the increments. The network connects the main location and the N+1 remote locations.

### BRIEF DESCRIPTION OF THE DRAWINGS

These and other features, aspects, and advantages of the present invention will become better understood with regard to the following description, appended claims, and accompanying drawings, where:

FIG. 1 is a block diagram illustrating a conventional approach to data recovery with a two-site system using disk arrays;

FIG. 2 is a block diagram illustrating a conventional three-site data recovery system;

FIG. 3 is a block diagram illustrating an exemplary method for distributing storage pages across multiple file subsystems;

FIG. 4 is a flow chart illustrating an exemplary method for redundant disk storage arrays;

FIG. 5 is a block diagram illustrating an exemplary embodiment for geographically distributed storage devices using six physical locations; one primary location and five backup locations;

FIG. 6 is a block diagram illustrating an exemplary embodiment for six physical locations that uses a full mesh network used to avoid any single or double points of failure;

FIG. 7 is a block diagram illustrating a conventional four-site data recovery system that allows recovery from up to 3 site failures;

FIG. 8 is a block diagram illustrating an exemplary embodiment having a geographically distributed architecture extended to five separate file subsystems;

FIG. 9 is a block diagram illustrating an exemplary embodiment for seven physical locations; and

FIG. 10 is a block diagram illustrating an exemplary embodiment for seven physical locations that uses a full mesh network to prevent single, double, and triple points of failure.

### DETAILED DESCRIPTION OF THE INVENTION

Exemplary embodiments are directed to methods, systems, and storage mediums for data recovery. Such storage devices are typically used to provide data recovery for computer data centers. Disks are used in this disclosure for illustration of storage devices. However, exemplary embodiments also include magnetic tape, optical disks, magnetic disks, mass storage devices, and other storage devices. Also, storage in terms of pages is used for illustration. Pages are simply a unit of measurement chosen for convenience. Exemplary embodiments include other measurements of storage such as files or databases.

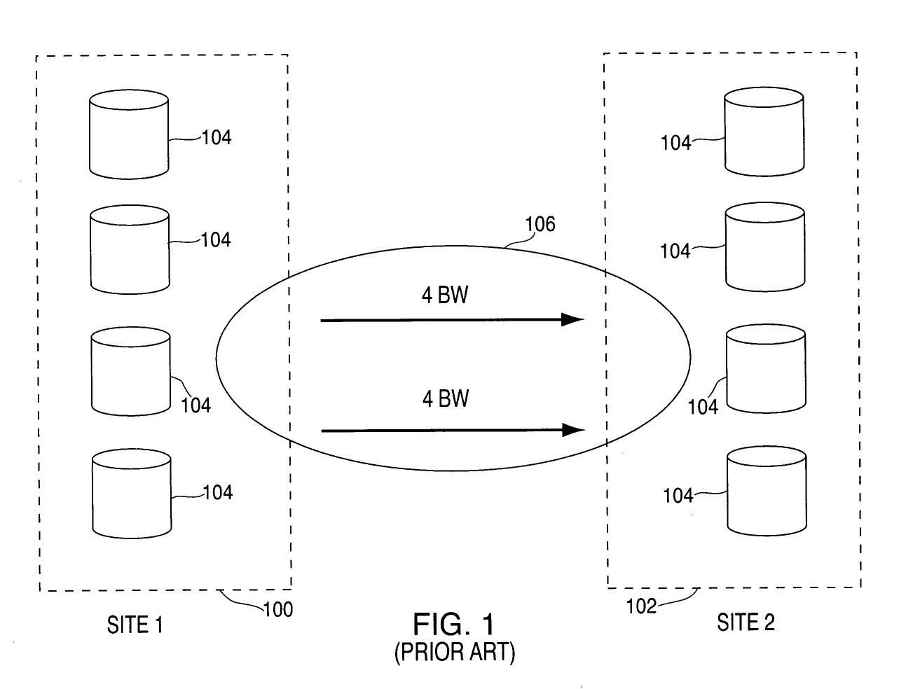

FIG. 1 illustrates a conventional approach to data recovery with a two-site system using disk arrays. In this example, there are two sites (e.g., buildings, computer centers, etc.) named site one 100 and site two 102. These sites 100, 102 are typically in different locations. For example, site one 100 might be located on Wall Street in New York and site two 102 might be located across the Hudson River in New Jersey. Site one 100 is typically a production site (a/k/a primary location) that generates and stores data in 4 disks 104. That data is backed up to the remote location (a/k/a backup location), site two 102 so that if a disaster happens that renders the primary location inoperable, access to the backed up data can be provided. Site two 102 has 4 identical disks 104. The disks 104 are backed up one for one. In this example, a fiber optical network 106 connects site one 100 to site two 102.

In this conventional approach, there are 4 disks 104 at site one 100 that are each backed up with a redundant disk 104 at site two 102. The disks 104 are interconnected with an optical link having sufficient bandwidth to carry the required data. All 8 of the disks 104 in the primary and backup locations are used to their full capacity. If each disk 104 holds one unit of storage, a total of 8 storage units are required. Storage units are generic and not necessarily the storage units on a disk. The link bandwidth is also used to full capacity, which is defined as 1 BW to be a reference point for later comparisons. The resulting configuration can recover completely if one of the sites is lost, although losing both sites will, of course, result in the loss of all data. Likewise, loss of the optical link between sites would make it impossible to back up further data. For this reason, 2 optical links are usually implemented with protection switching between them, each being capable of accommodating the full required bandwidth, for a total of 2 BW required. In summary, the conventional 2-site data recovery system in FIG. 1 shows 8 disks at 100% capacity, 8 units of storage, and 2 BW.

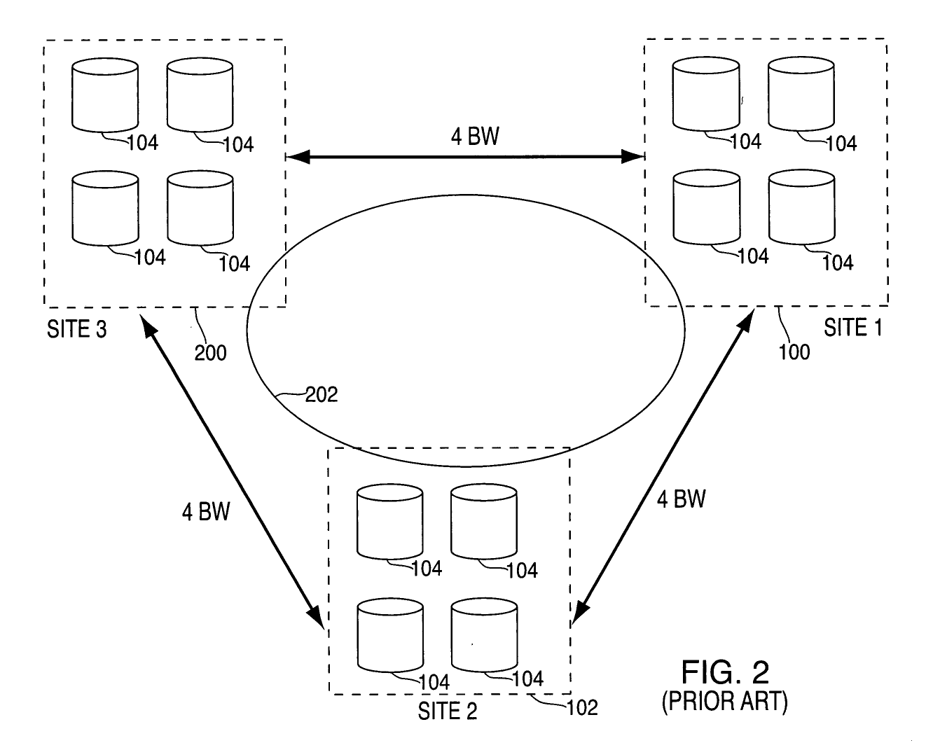

FIG. 2 illustrates a conventional 3-site data recovery system. If a customer wants to protect more than 2 data centers or wants to protect against 2 data centers failing at once, (e.g., a blackout covering a large area) then a third site 300 may be added to this configuration as shown in FIG. 2. In order to fully protect against the loss of any 2 data centers, this configuration requires a total of 12 disks and full bandwidth on all 3 inter-site links. The sites are physically connected in a fiber ring 202 so that failure of any one inter-site link allows all 3 sites to remain interconnected. The required number of disks and network bandwidth do not scale well when increasing either the number of sites or the amount of storage to be backed up. In summary, the conventional 3-site recovery system in FIG. 2 shows 12 disks at 100% capacity and 3 BW. To add another site (4 sites) would require 16 disks at 100% capacity and 4 BW and so on. For n sites, there would be 4*n disks and n BW.

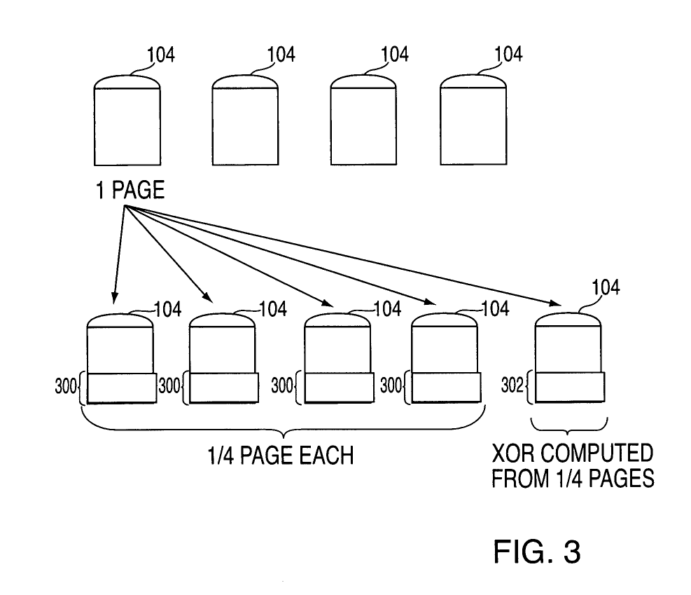

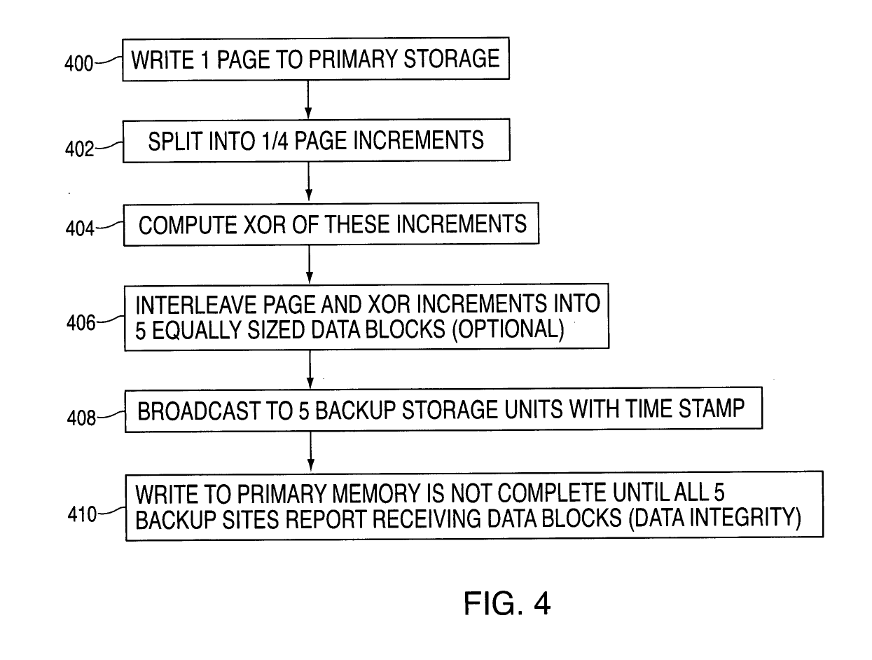

FIG. 3 illustrates an exemplary method for distributing storage pages across multiple file subsystems. This exemplary embodiment is configured so that the data is not backed up on fully utilized disks. Instead, as shown in FIG. 3, the amount of data normally stored on 4 disks 104 is split across 5 disks at less than 100% utilization. For example, a page stored on the first device is split into 4 quarter-pages 300, each stored on a different device. The fifth device stores the result of an exclusive or (XOR) operation 302 on the data frames of the 4 quarter-pages 300. In this way, all of the data is recoverable, if any one disk fails. The XOR 302 and remaining 3 quarter-pages 300 are used to reconstruct the missing quarter page. In practice, a combination of data and XOR information is stored at each disk. For simplicity, in this example embodiment, consider all the XOR information 302 to be stored in one location. Next, the 5 storage devices are geographically distributed from the primary facility to remote locations. Logically, there are 5 point-to-point connections, each using ¼ BW, while physically the fibers are connected in a ring. A read or write operation to storage is not considered complete for data integrity purposes, until all 5 backup sites acknowledge receipt of the backup data. An exemplary method using this approach is outlined in FIG. 4.

FIG. 4 illustrates an exemplary method for redundant disk storage arrays. At 400, one page is written to primary storage. Then, at 402, the page is split into ¼ page increments. At 404, an XOR is computed of these increments. At optional step 406, the page and XOR increments are interleaved into 5 equally sized data blocks. At 408, there is a broadcast to 5 backup storage units with a time stamp. Finally at 410, the write to primary memory is not complete until all 5 backup sites report receiving data blocks, for data integrity. This exemplary method is for 5 backup sites, but could be scaled up to any number of backup sites. Optional error checking and/or encryption is performed in some exemplary embodiments of this method. In some exemplary embodiments, pages may be distributed in various ways, so long as the data is distributed evenly.

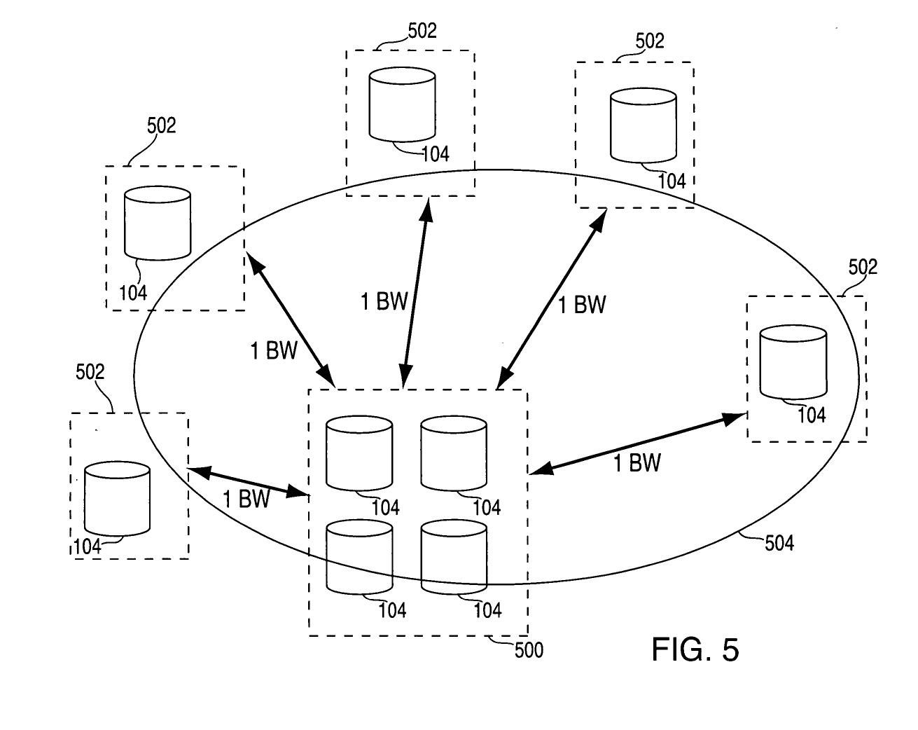

FIG. 5 illustrates an exemplary embodiment for geographically distributed storage devices using 6 physical locations. There is one main location 500, and five remote locations 502, which are interconnected with a ring of optical fibers 504. The ring of optical fibers 504 protects against fiber cuts and/or site failures, but it may still isolate an operational node if two non-adjacent nodes fail. Copies of the four disks 104 at the main location 500 are copied to disks 104 at four of the five remote locations 502 and XOR information is stored at the other remote location 502 using the exemplary method of FIG. 4. If data at the main location 500 or any one remote location 502 is lost, all the data is recoverable.

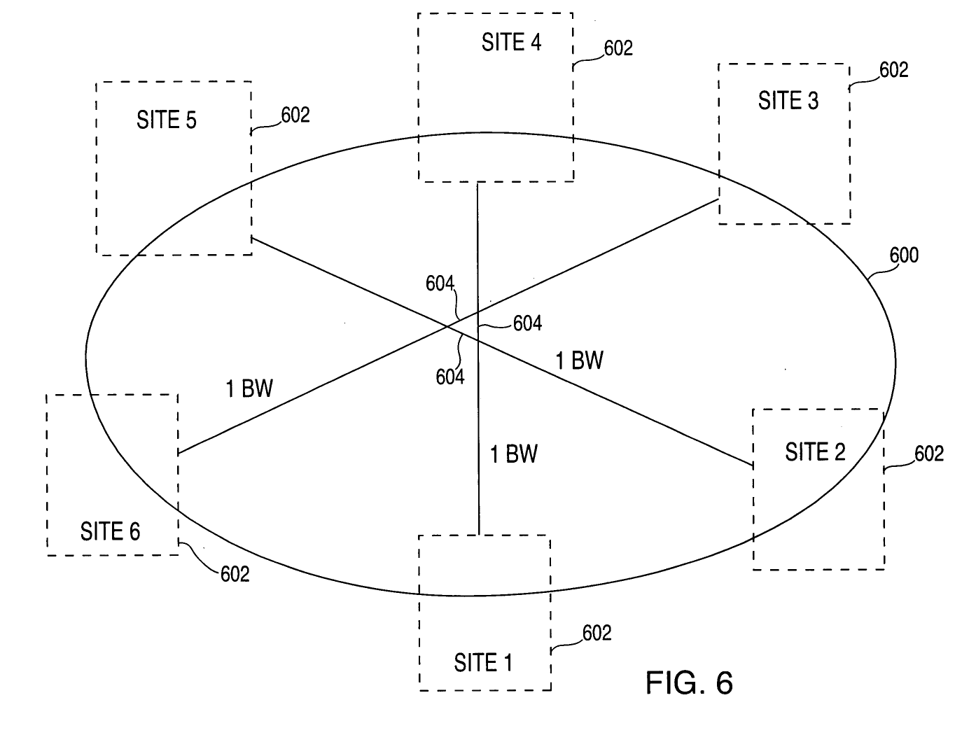

The exemplary embodiment of the multi-site system shown in FIG. 5 compares favorably with the conventional multi-site system shown in FIG. 2. In FIG. 5, the 6-site system has 9 disks and 5 BW. In FIG. 2, the conventional 3-site system has 12 disks and 12 BW. FIG. 5 shows more physical locations, the same functionality (all data can be recovered after the loss of any two sites), but shows 9 disks and 5 BW instead of 12 disks and 12 BW, as shown in FIG. 2. FIG. 5 shows more physical sites; however, customers have been asking for more physical sites. Also, the conventional approach shown FIG. 2 is faster to recover than the exemplary embodiment in FIG. 5, because of the difference in bandwidth. This disadvantage is remedied in the exemplary embodiment illustrated in FIG. 6.

FIG. 6 illustrates an exemplary embodiment for six physical locations that uses a full mesh network 600 to avoid all single and double points of failure. This exemplary embodiment includes a geographically distributed array of redundant disk storage devices (GDRD) that are interconnected with high bandwidth optical links as an extension of the conventional remote copy architecture. This exemplary embodiment is like the 6-site system shown in FIG. 5 (5 BW) with the addition of the mesh network 600. The mesh network 600 includes additional redundancy in connecting the six sites 602 by adding three additional fiber links 604 that are cross-connected (3 BW). If two non-adjacent nodes on the ring are physically destroyed, then the intermediate nodes are isolated from the rest of the ring. Protection against any network point of failure is provided by this exemplary embodiment by using a full mesh rather than a single ring. This slightly increases the required bandwidth, but is still a significant savings over the conventional approach. In summary, FIG. 6 shows 9 disks and 8 BW (8 BW=3 BW+5 BW), which still compares favorably to the conventional approach shown in FIG. 2 with 12 disks and 12 BW.

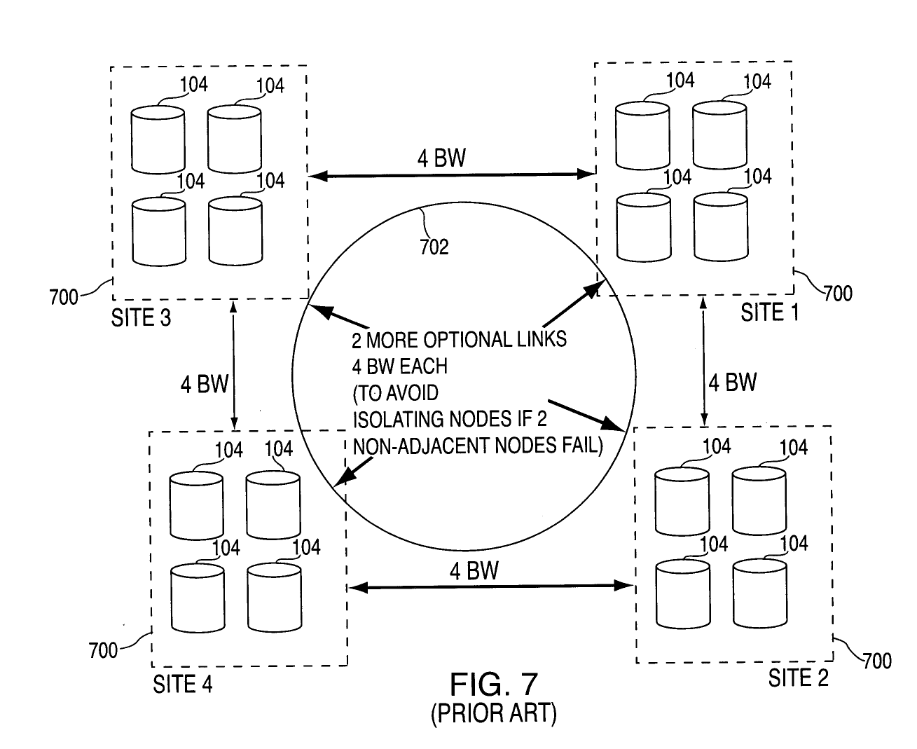

FIG. 7 illustrates a conventional four-site data recovery system. There are four sites 700, each having 4 disks 104 for a total of 16 disks 104. There is a network 702 with at least 16 BW, including four links (4*4 BW=16 BW). Two more optional links (2*4 BW=8 BW) are required to avoid isolating nodes if two non-adjacent nodes fail.

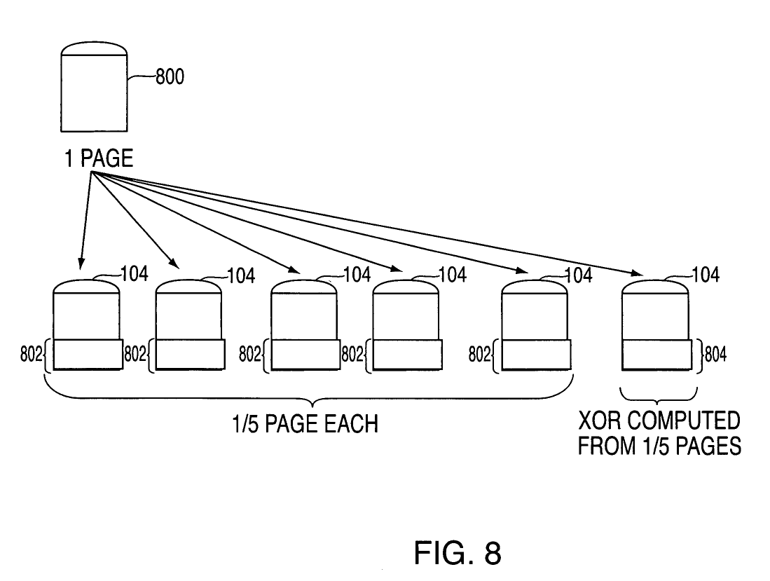

FIG. 8 illustrates an exemplary embodiment having a geographically distributed architecture extended to five separate file subsystems. This exemplary embodiment is able to recover data after the loss of any three sites. A page of memory 800 is split into fifths to store ⅕ page 802 each across five disks 104 and XOR information 804 is stored on a sixth disk 104.

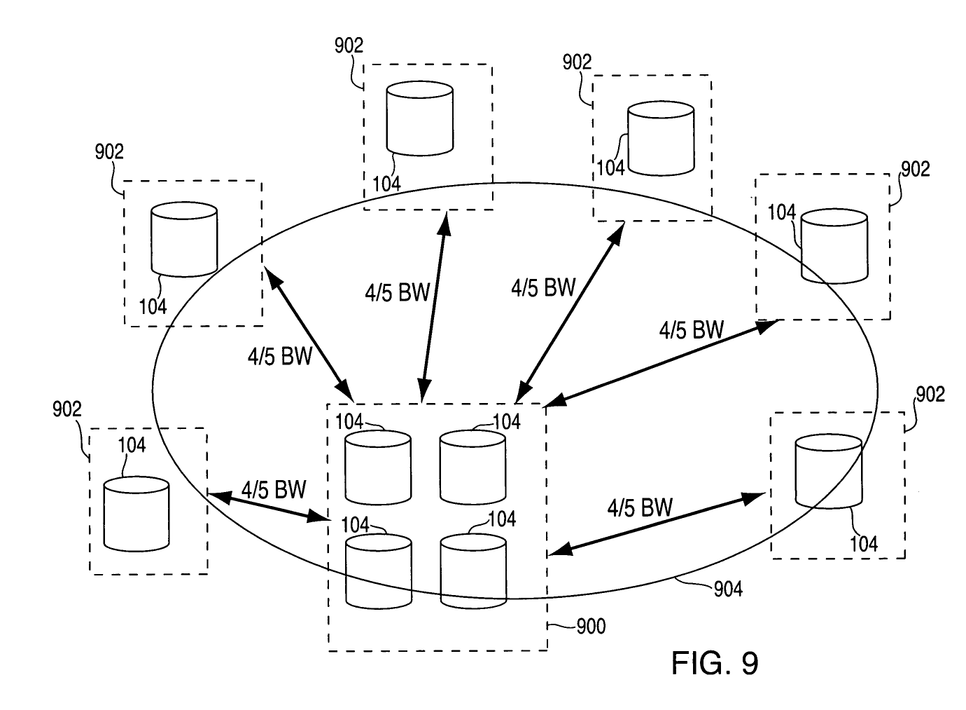

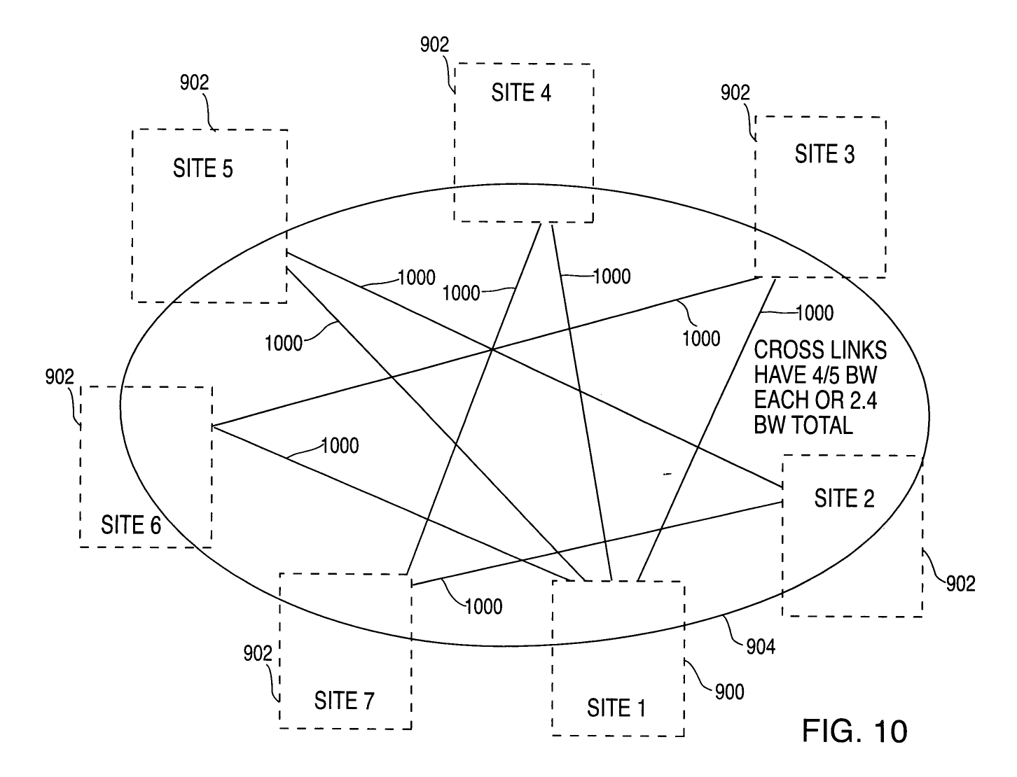

FIG. 9 illustrates an exemplary embodiment for seven physical locations. This exemplary embodiment, like the four-site recovery system illustrated in FIG. 7, is able to recover data after the loss of any three sites. There is a main location 900 and six additional locations 902 interconnected by a network 904, which is a fiber ring. In summary, this exemplary embodiment uses 10 disks 104 and 4.8 BW. To prevent the isolation of any node, network 904 can be converted into a full mesh topology, as shown in FIG. 10.

FIG. 10 illustrates an exemplary embodiment for seven physical locations that uses a full mesh network to prevent single, double, and triple points of failure. Cross-links 1000 are added to network 904 to construct a full mesh topology.

The exemplary embodiments have many advantages in network bandwidth utilization. Because the link bandwidth is not fully utilized between each site, other traffic can share the same physical network. The network cost may thus be amortized over multiple customers or applications as opposed to the conventional approach that requires the full link bandwidth to be dedicated to data recovery from a single customer at all times. This facilitates convergence of data and other applications on a common network.

Further, for large data block sizes, the recovery time for some types of failures is faster using exemplary embodiments. For example, when the primary site is temporarily unavailable and later returns to operation, data is remote copied from the backup site across multiple links, improving recovery time relative to approaches using a single recover link at the same bandwidth.

Using the conventional approach, the recovery time is the time required for all disks at the backup site to access their data and transmit back to the primary site. Using exemplary embodiments, data is simultaneously transmitted from several remote sites back to the primary site, potentially reducing the recovery time by about up to 4 times. Exemplary embodiments also scale much better than prior approaches when multiple sites or larger amounts of storage are involved.

Exemplary embodiments of the present invention have many advantages. Exemplary embodiments include geographically distributed arrays or redundant disk storage devices that are interconnected with high bandwidth optical links, providing recovery from multiple site failures with less disk storage, less bandwidth, and lower cost than conventional approaches and with faster recovery in some cases. Additional advantages include improved scalability, improved performance, and improved reliability.

Some exemplary embodiments have improved scalability. Exemplary embodiments are scalable to larger networks with greater amounts of storage than conventional recovery schemes. For example, exemplary embodiments provide equivalent data recovery protection to conventional schemes, but use only a fraction of the storage space and network bandwidth for equivalent amounts of data. Larger installations exhibit even greater savings when using some exemplary embodiments. This significantly lowers the cost of implementation for large networks.

Some exemplary embodiments have improved performance. In some exemplary embodiments, each page of data to be stored is split into multiple fractional pages and their exclusive or (XOR) is computed. These results are then distributed to different physical locations so that a failure in any one site does not result in any lost data. For large data blocks, the recovery time is greatly reduced. In addition, the required bandwidth in the fiber optic network is less than for conventional recovery schemes. Furthermore, extending the distance between sites does not significantly impact the storage access times. Each disk has roughly 5 ms average access time, which is comparable to the latency over a 1000 km optical link. Thus, data centers geographically distributed over a large radius can have no more than roughly double the storage access time as a local as a data center on a single site. For links in the 50-100 km range, which are more typical, the additional impact of latency on disk access time is minimal.

Some exemplary embodiments have improved reliability. Some exemplary embodiments prevent any single point of failure in either the storage device or the optical network from affecting its ability to recover all of the stored data. Other exemplary embodiments prevent even two or three failures in either the storage devices at different sites or the optical network from affecting its ability to recover all of the stored data.

As described above, the embodiments of the present invention may be embodied in the form of computer-implemented processes and apparatuses for practicing those processes. Embodiments of the present invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the present invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits.

While the present invention has been described with reference to exemplary embodiments, it will be understood by those skilled in the art that various changes may be made and equivalents may be substituted for elements thereof without departing from the scope of the present invention. In addition, many modifications may be made to adapt a particular situation or material to the teachings of the present invention without departing from the essential scope thereof. Therefore, it is intended that the present invention not be limited to the particular embodiment disclosed as the best mode contemplated for carrying out this invention, but that the present invention will include all embodiments falling within the scope of the appended claims. Moreover, the use of the terms first, second, etc. do not denote any order or importance, but rather the terms first, second, etc. are used to distinguish one element from another.

What is claimed is:

1. A method for data recovery, comprising:
writing a storage unit of memory to a primary storage device at a main location;
dividing the storage unit of memory into increments, each increment being 1/n of the storage unit of memory, (n+1) being a number of remote locations, n being at least two;
computing an exclusive-or (XOR) result of an XOR operation on the increments;
sending the increments and the XOR result to a plurality of backup storage devices at the remote locations; and
recovering the storage unit of memory.

2. The method of claim 1, further comprising:
interleaving the increments and the XOR result into (n+1) equally sized data blocks.

3. The method of claim 1, further comprising:
recovering the storage unit of memory, if the primary storage device fails or if any one of the backup storage devices at the remote locations fails.

4. The method of claim 1, further comprising:
receiving reports of successful backups from all of the remote locations to verify data integrity.

5. The method of claim 1, wherein the increments are broadcast to the backup storage units with a time stamp.

6. The method of claim 1, wherein the stored unit of data is a page of memory.

7. The method of claim 1, wherein the stored unit of data is a computer file.

8. A system for data recovery, comprising:
a main location having N primary storage devices;
N+1 remote locations having N+1 backup storage devices for storing 1/N page increments of each page of data from the N+1 primary storage devices and an exclusive-or (XOR) result of an XOR operation on the increments; and
a network connecting the main location and the N+1 remote locations.

9. The system of claim 8, wherein data lost at the main location or any of the N+1 remote locations is recoverable.

10. The system of claim 8, wherein data lost at any three sites is recoverable, the sites including the main location and the N+1 remote locations.

11. The system of claim 8, wherein the network is a full mesh network.

12. A storage unit having instructions stored thereon for performing a method of data recovery, the method comprising:
writing a storage unit of memory to a primary storage device at a main location;
dividing the storage unit of memory into increments, each increment being 1/n of the storage unit of memory, (n+1) being a number of remote locations, n being at least two;
computing an exclusive-or (XOR) result of an XOR operation on the increments;
sending the increments and the XOR result to a plurality of backup storage devices at the remote locations; and
recovering the storage unit of memory.
